(19) United States
(12) Patent Application Publication
(10) Pub. No.: US 2025/0256448 A1
(43) Pub. Date: Aug. 14, 2025

(54) JACKETED FOAM POLYMER MEMBERS, FENESTRATION ASSEMBLIES, AND METHODS FOR SAME

(71) Applicant: Marvin Composites, LLC, Fargo, ND (US)

(72) Inventors: Robert P. Plagemann, Fargo, ND (US); Samantha Uzelac, Reiles Acres, ND (US); Jesse Vetsch, Fargo, ND (US); Daniel Ronnevik, Fargo, ND (US); Josh Gornowicz, Fargo, ND (US)

(21) Appl. No.: 19/049,444

(22) Filed: Feb. 10, 2025

Related U.S. Application Data
(60) Provisional application No. 63/552,047, filed on Feb. 9, 2024.
(60) Provisional application No. 63/555,797, filed on Feb. 20, 2024.

(51) Int. Cl. B29C 48/21; B29K 105/04; B29K 105/08; B29K 105/16; B29L 31/00; E06B 3/26; E06B 3/263; E06B 3/267; E06B 3/30

(52) U.S. Cl. CPC B29C 48/21; E06B 3/26; E06B 3/267; E06B 3/30; B29K 2105/04; B29K 2105/08; B29K 2105/16; B29K 2995/0015; B29K 2995/0017; B29K 2995/0029; B29L 2031/005; E06B 2003/26354; E06B 2003/26378

(57) ABSTRACT

A fenestration assembly includes a fenestration frame includes one or more frame members. The fenestration frame is coupled with one or more panels. Each frame member includes a coextruded foam polymer frame member. The coextruded foam polymer frame member includes a foam polymer core and a polymer shell jacketing the foam polymer core. The polymer shell is coextruded with the foam polymer core. The polymer shell braces the foam polymer core against deformation.

### CLAIM OF PRIORITY

This patent application claims the benefit of U.S. Provisional Patent Application No. 63/552,047, filed Feb. 9, 2024, and U.S. Provisional Patent Application No. 63/555,797, filed Feb. 20, 2024, which are incorporated herein by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the data and drawings that form a part of this document: Copyright Marvin Cedar Company (d/b/a Marvin Windows and Doors); Warroad, MN. All Rights Reserved.

### TECHNICAL FIELD

This document pertains generally, but not by way of limitation, to fenestration assemblies and lineal components of fenestration assemblies.

### BACKGROUND

Fenestration assemblies are constructed with one or more materials, such as wood, polymers, metals (e.g., aluminum), or the like. Wood is relatively easy to cut to size and shape for fenestration assemblies and includes a solid structure that holds fasteners, including brackets, nails, screws, or the like. Polymer fenestration assemblies include hollow polymer components that are, in some examples, extruded or the like. In various examples, polymer fenestration assemblies are resistant to heat transfer and are potentially subject to less maintenance than wood fenestration assemblies. Aluminum or metal fenestration assemblies have a robust structure and, in some examples, are subject to less maintenance than wood fenestration assemblies.

### Overview

The present inventors have recognized, among other things, that a problem to be solved can include addressing shortcomings of fenestration materials that use one or more of wood, polymer, or metal in their construction.

Wood is generally easy to cut to desired lengths and shapes as components of the fenestration assembly frame and sash (or sashes). Additionally, wood fenestration assemblies have a solid structure that readily holds fasteners like brackets, nails, screws, or the like. This is sometimes referred to as the fasteners having material to ‘bite.’ In contrast, hollow polymer or metal fenestration components include, in some examples, blocking, brackets, or the like that are inserted into cavities of those fenestration components to provide additional material for reception and fixing fasteners. In some examples, wood fenestration assemblies are subject to damage from moisture. Over time, moisture infiltrates, for example, wood assemblies, and may cause rotting, warping, or the like, damaging the assembly and its finishes and potentially surrounding portions of the building. Maintenance is required to address these issues, for instance, with reapplication of a finish, replacement of rotted or warped components, or replacement of the fenestration assembly.

In some examples, polymer fenestration assemblies are resistant to moisture

infiltration, warping, and rot. Accordingly, some polymer fenestration assemblies require less maintenance than their wood counterparts. Additionally, polymer fenestration assemblies are hollow, constructed with polymers, and, in some examples, provide greater thermal insulation in comparison to metal assemblies.

In other examples, polymer fenestration assemblies lose structural integrity, warp under load, or deform when subjected to high temperatures, sunlight, or the like. The material of the polymer fenestration assemblies has a property called Heat Deflection Temperature (HDT). The HDT is the temperature under which the material will permanently deform under a predesignated stress level. PVC, for example, has an HDT around 140° F. Polymer fenestration assemblies made of PVC, for example, may absorb heat of, for example, 40° F. adding to the ambient temperature outside of, for example, 110° F., totaling 150° F., which surpasses the HDT of the PVC (around 140° F.), possibly causing permanent deformation to the fenestration assembly.

In general, darker colors absorb more heat than lighter colors (e.g., white) because lighter colors reflect more energy than darker colors. For that reason, in some cases, lighter colors (like white) are mandated to mitigate heating that otherwise would damage the assembly by causing fading, loss of structural integrity, warping under load, or the like.

Additionally, hollow polymer assemblies provide a small (hollow) end profile for fastening because of the extrusion processes. Fastening of end profiles, in some examples, includes the addition of joint fittings, welding, or the like, and the small end profile, in some examples, provides a weak or difficult-to-connect joint.

In various examples, polymer fenestration assemblies are limited to smaller-profile fenestration assemblies or are reinforced with metal extrusion or wooden inserts inside of the profile to maintain their structural integrity. Accordingly, larger profile polymer fenestration assemblies (e.g., in various design profiles, fenestration assemblies wider than 3 feet, fenestration assemblies taller than 6 feet, or the like) include, in some examples, one or more metal or wood reinforcements to enhance the structural integrity of the fenestration assembly (e.g., give extra support, maintain true, square, plumb, and level).

Metal fenestration assemblies, such as aluminum, have a robust structure in comparison to polymers and, potentially, wood. Accordingly, metal assemblies have increased durability and, in some examples, require less maintenance. However, in general, metal fenestration assemblies conduct more heat than polymer fenestration assemblies. For example, a metal fenestration assembly made of aluminum has a thermal conductivity of approximately 1160 (BTU*in.)/(hr.*ft2*° F.) whereas a polymer fenestration assembly made of PVC has a thermal conductivity of approximately 1.2 (BTU*in.)/(hr.*ft2*° F.).

The material properties of the fenestration assemblies and the thickness of the profile impact the conductive insulating value of the fenestration assembly. The metal material, for example, enhances heat transfer and conversely decreases the thermal insulation of the fenestration assembly in comparison to wood or polymers.

Metal fenestration assemblies are extruded and, accordingly, are hollow. Another impact on the conductive insulating value of the fenestration assembly is the presence of hollows. Profiles with large hollows, such as in metal fenestration assemblies, can have conductive heat currents flow through their hollows, negatively affecting thermal performance. In contrast, polymer fenestration assemblies (e.g. PVC profiles) have several small hollows to improve thermal performance with respect to thermal convection.

Additionally, in various examples, the hollow profile of the metal assembly provides decreased substrate for fixing fasteners like brackets, nails, screws, or the like. In some examples, aluminum fenestration assemblies have a relatively thin wall (e.g., two to three millimeters), and the thin wall provides less material for fixing fasteners, like brackets, nails, screws, or the like (e.g., the fasteners have poor ‘bite’).

Optionally, metal fenestration assemblies incorporate blocking, plates, supplemental brackets, or the like, in the cavities to engage with and cooperatively fix fasteners relative to the thin walls. In some instances, the fasteners may have more material for fixation than in polymer assemblies, but still less than wood assemblies.

The present subject matter can help solve these problems, with fenestration assemblies having foam polymer members. As described herein, the jacketed members include foam polymer cores surrounded (e.g., fully enclosed or partially enclosed) by polymer shells that brace the foam polymer cores. The polymer shell enhances the strength of the foam polymer core and provides a robust framework to support the jacketed foam polymer member.

The jacketed foam polymer members provide a greater surface area at the ends in comparison to hollow profile members. For instance, the greater surface area facilitates welding and adhesion by providing ample surfaces for coupling in contrast to the edges of hollow profiles. Accordingly, welded, adhered, or fastened joints at the end profiles are robust, durable, and resistant to moisture penetration in comparison to hollow profile couplings.

Foam polymer cores also provide a solid substrate that anchors (e.g., grips) fasteners therein. Accordingly, fasteners, such as nails, screws, bolts, or the like, are readily received and anchored (e.g., bite) within the foam polymer core. Backers, fillers, blocks, or brackets used with hollow profile fenestration assemblies to facilitate hardware attachment of hinges, operators, locks, and the like are accordingly avoided with the foam polymer cores described herein.

Moreover, the foam polymer cores provide a substrate within the polymer shell that decreases voids otherwise present in hollow profile fenestration assemblies. In one example, the foam polymer core enhances the thermal performance of the fenestration assembly by decreasing convective heat transfer. Optionally, the foam core includes pores, cells, or the like (reticulated or non-reticulated) that provide interstitial cavities to further enhance thermal insulation.

In one example, the fenestration assembly includes a cap layer that is optionally coextruded with the polymer shell. The cap layer is optionally placed on the exterior of the polymer shell to enhance the weatherability of the fenestration assembly. In other examples, the cap layer enhances the thermal stability of the underlying filament polymer shell and permits the application of darker colors according to the aesthetic specifications of the customer or builder.

In another example, the foam polymer core includes a first mechanical strength characteristic (e.g., compressive, tensile, yield, fatigue, flexural, or the like), and the polymer shell includes a second mechanical strength characteristic greater than the first mechanical strength characteristic. The polymer shell, having the greater mechanical strength, braces the foam polymer core and enhances the mechanical characteristics of the fenestration assembly. For instance, mechanical strength (e.g., tensile strength, yield strength, creep resistance, flexural strength, or the like) of the fenestration assembly is enhanced by the shell, thereby permitting the construction and support of larger windows than otherwise permitted with hollow profile polymer assemblies. As described herein, the enhanced mechanical strength and thermal stability of the foam polymer members cooperate to resist bending, deformation, or the like due to load, heat, or the like.

In another example, the foam polymer core includes a first thermal stability characteristic, and the polymer shell includes a second thermal stability characteristic. Optionally, the second thermal stability characteristic is greater than the first thermal stability characteristic. In this example, the shell having the greater thermal stability characteristic forms a jacket around the foam polymer core that braces the core and constrains expansion, contraction, or bending of the core when the fenestration assembly experiences temperature fluctuations.

This overview is intended to provide an overview of the subject matter of the present patent application. It is not intended to provide an exclusive or exhaustive explanation of the invention. The detailed description is included to provide further information about the present patent application.

### BRIEF DESCRIPTION OF THE SEVERAL VIEWS OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of a fenestration assembly.

FIG. 2 is a perspective view of another example of a fenestration assembly.

FIG. 3 is a cross-sectional view of an example of a fenestration assembly including a coextruded foam polymer member.

FIG. 4A is a cross-sectional view of an example of a fenestration sash including a hollow core and a foam polymer core.

FIG. 4B is a cross-sectional view of one example of a fenestration frame including a hollow core and a foam polymer core.

FIG. 5 is a cross-section view of another example of a fenestration assembly including coextruded foam polymer member and hollow member.

FIG. 6 is a block diagram showing one example of a method of making a fenestration assembly.

### DETAILED DESCRIPTION

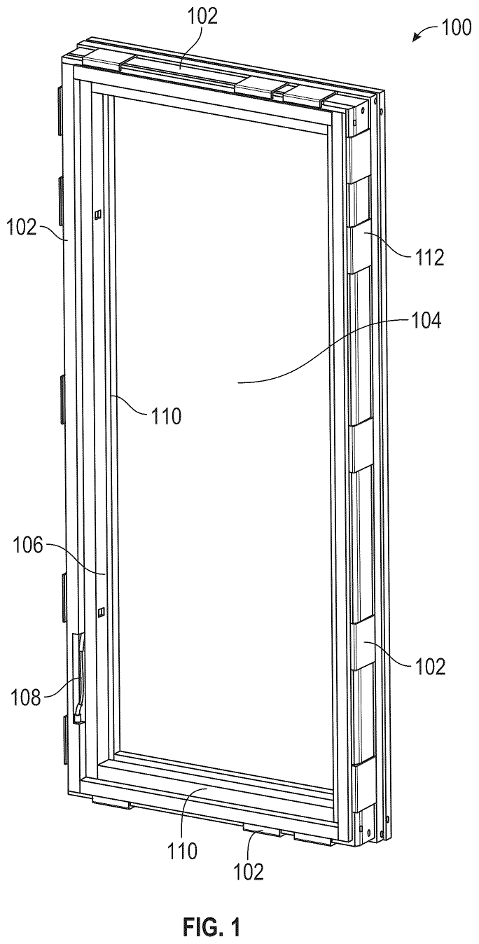

In reference to the Figures, FIG. 1 is a perspective view of one embodiment of a fenestration assembly 100. In this embodiment, the fenestration assembly 100 includes a window assembly having an operable panel, such as sash 106 movably coupled with a fenestration frame 112.

The fenestration assembly 100, in this example, is a casement window. In other examples, the fenestration assembly 100 includes, but is not limited to, other kinds of window assemblies (e.g., double hung, single hung, single sliding, double sliding, venting window, hopper windows, awning windows, stacker door, or the like), door assemblies (refrigerator doors, freezer doors, sliding doors, single-folding doors, hinged doors, pivot doors, or the like), solar panel, or the like, having a moveable or stationary sash or panel.

In one example, the sash 106 is a swinging sash such as that shown with the casement window provided in FIG. 1. In other examples, the sash 106 moves translationally within the frame member 102 of the fenestration assembly 100, for instance, in the manner of a single or double hung window.

In various examples, the fenestration assembly 100 includes a sash 106 coupled with the fenestration frame 112 and the sash 106 having one or more sash frame members, such as the sash frame member 110. In various examples, the sash frame member 110 includes a coextruded foam polymer member. Optionally, a panel 104, such as a glass panel, insulated glazing unit (IGU), opaque panel, solar panel, or the like, is installed in the sash frame members 110. For instance, in one example, a window fenestration assembly includes a translucent panel. In another example, a door fenestration assembly includes either a translucent or opaque panel.

The fenestration assembly 100 includes a fenestration frame 112 having one or more frame members, such as frame member 102, a panel 104 coupled with the fenestration frame 112, and fenestration hardware 108.

In various examples, one or more frame members 102 of the fenestration frame 112 and one or more sash frame members 110 of the sash 106 include a coextruded foam polymer member having a polymer shell jacketing a polymer core that is coextruded with the polymer core. As described herein, the polymer shell braces and supports the foam polymer core. Additionally, the polymer shell enhances the strength of the foam polymer core and provides a robust framework to support the coextruded foam polymer member. During coextrusion, the polymer shell encapsulates the foam polymer core ensuring the foam polymer core has a complementary profile (e.g., that matches) to the interior of the polymer shell.

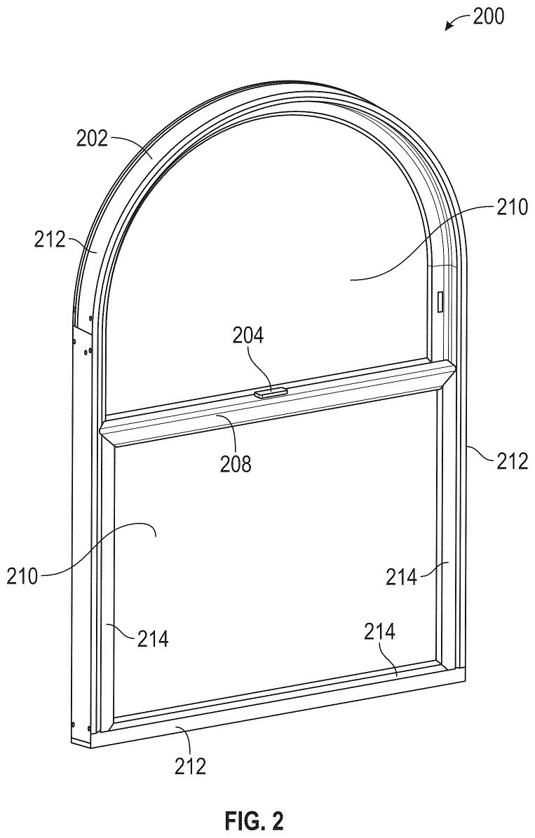

Referring now to FIG. 2, another example of a fenestration assembly 200 is shown. In this example, the fenestration assembly 200 illustrates a single hung window including a fenestration frame 202, fenestration hardware 204, a stationary sash 206, and a movable sash 208.

As with the fenestration assembly 100, shown in FIG. 1, the fenestration assembly 200 includes, but is not limited to, other kinds of window assemblies (e.g., double hung, single hung, single sliding, double sliding, venting window, hopper windows, awning windows, stacker door, or the like), door assemblies (refrigerator doors, freezer doors, sliding doors, solar panels, single-folding doors, bi-or multi-panel folding doors, hinged doors, pivot doors, or the like), or the like, having a moveable or stationary sash or door panel.

As with the previous fenestration assembly 100, in various examples, the fenestration assembly 200 includes a fenestration frame 202 having one or more coextruded foam polymer frame members 212. In other examples, the fenestration assembly 200 having the movable sash 208 includes one or more coextruded foam polymer sash members 214.

As described herein, the one or more frame members 102 having coextruded foam polymer members (coextruded foam polymer frame members 212 or coextruded foam polymer sash members 214) include a polymer shell (optionally reinforced with a plurality of filaments) that is coextruded with a foam polymer core. For instance, the polymer shell encapsulates the foam polymer core during coextrusion and accordingly ensures the foam polymer core has a complementary profile (e.g., that matches) to the interior of the polymer shell.

The foam polymer core is created with a formulated polymer (e.g., PVC) and a blowing agent to create specified densities of foam (e.g., between 0.3 and 0.8 specific gravity). As described herein, the foam polymer core provides a large surface for welding contact and adhesion, in contrast to point or edge interfacing surfaces. The foam polymer core also provides a backing material for fixating, for example, fenestration hardware, such as fenestration hardware 204 (e.g., hinges, locks, fasteners such as screws, nails, bolts, or the like). The foam polymer core fills the coextruded foam polymer member, enhances thermal performance and decreases (including eliminating) convective heat loss and transfer.

In some examples, polymer fenestration assemblies lose structural integrity, warp under load, or deform when subject to high temperatures, sunlight, combinations of the same or the like. Polymer fenestration assemblies have a characteristic referred to as Heat Deflection Temperature (HDT). The HDT is the temperature the material will permanently deform under a predesignated stress level. PVC by itself, for example, has an HDT around 140° F. Polymer fenestration assemblies made of PVC may absorb heat from solar radiation, for instance 40° F., adding to an ambient exterior temperature of, for example, 110° F. The resulting total temperature of 150° F. surpasses the HDT of the PVC and, when under stress (e.g., from building framing around the assembly), the fenestration assembly potentially deforms (e.g., warps, deflects, or the like) in a permanent manner. Warping may bind otherwise movable sashes, door panels, or the like and cause them to seize within the frames and resist (or prevent) movement.

In general, darker colors absorb more solar heat (radiation) than lighter colors (e.g., white, beige, or the like) because lighter colors reflect more energy than darker colors. For that reason, in some cases, lighter colors (like white) are mandated, in fenestration assemblies, to mitigate heating that otherwise damages the assembly by causing fading, loss of structural integrity, warping under load, or the like.

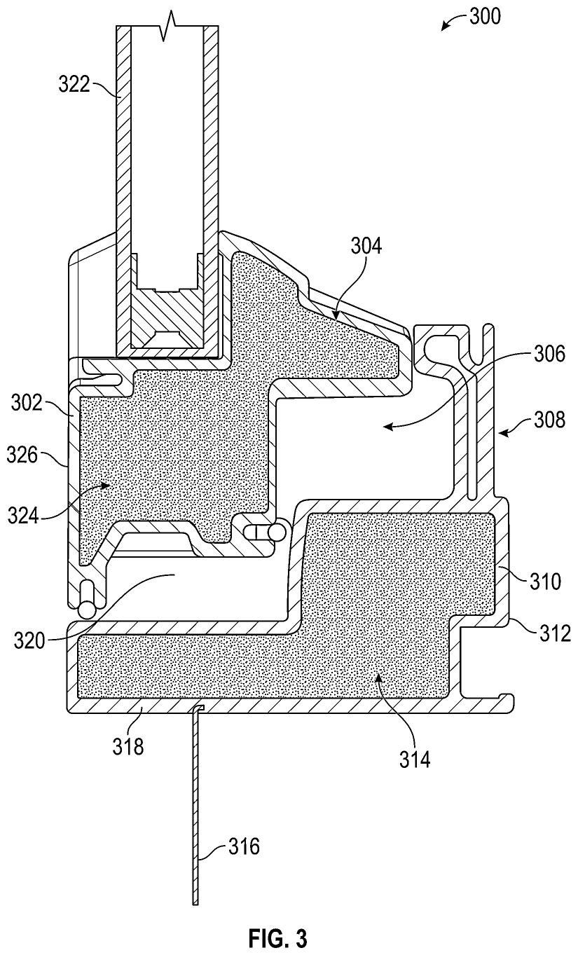

FIG. 3 shows an example cross-sectional view of a fenestration assembly 300, according to some embodiments. As shown in FIG. 3, the fenestration assembly 300 includes a fenestration frame 318 having one or more foam polymer frame members, such as foam polymer frame member 310, coupled with a sash 302 having one or more polymer sash members, such as the foam polymer sash member 304.

In various examples, as shown in FIG. 3, there is a fenestration hardware cavity 306 and a fenestration mechanism cavity 320 between the fenestration frame 318 and the sash 302 that receive installed hardware, mechanisms, or the like (e.g., to latch the assembly, operate the assembly, for instance, move a casement window sash, or the like).

The one or more foam polymer members (of either or both of the sash 302 or frame 318) include a polymer shell 312, 326 coextruded with a foam polymer core 314, 324. In various examples, the polymer shell 312, 326 includes a loaded polymer material, that is, the polymer shell 312, 326 includes a polymer (e.g., PVC, ABS, cPVC, PE (polyethylene), polypropylene, ASA, PMMA (acrylics), PPO, PC, PA 6, PA 6/6 (nylons), TPO, HIPS, TPUs, or the like) infused with a plurality of filaments or particles (including particulate) for reinforcement.

In other examples, the plurality of filaments or particles in the polymer shell 312, 326 have a filament or particle component including one or more of glass, mineral (e.g., wollastonite, calcium carbonate, talc, titanium dioxide (TiO2), or the like), organic fiber (e.g., cotton, wool, wood fiber, flax, hemp, or the like), a blend of glass and mineral, a blend of glass and organic fiber, a blend of a mineral and an organic fiber, a blend of glass, mineral and organic fiber, particles of the same or the like.

In one example, the polymer shell 312, 326 includes a blend of glass and mineral between 15% and 47% by weight. In another example, the polymer shell 312 includes a blend of glass and mineral between 5% and 60% by weight. In other examples, a blend of glass and mineral between 55% and 60% by weight. In another instance, a blend of glass and mineral between 40% and 48% by weight. In several other examples, a blend of glass and mineral between 25% and 35% by weight. In various other examples, a blend of glass and mineral between 12% and 17% by weight, or the like.

The polymer shell 312, 326 enhances the strength of the foam polymer core 314, 324 and provides a robust framework to support the coextruded foam polymer member (of either or both of the sash 302 or frame 318). The amount and the type of reinforcement incorporated in the polymer shell 312 are adjusted to the specifications of an application.

In some examples, the coextruded foam polymer members (302, 318, or both) provide a greater surface area at the ends in comparison to hollow profile members. The greater surface area facilitates welding and adhesion by providing broad surfaces for coupling in contrast to the edges of hollow profiles. Accordingly, welded, adhered, or fastened joints at the end profiles are robust, durable, and resistant to moisture penetration in comparison to hollow profile couplings that may crack, leak, or fail.

In various examples, the polymer fenestration assemblies described herein are resistant to moisture infiltration, warping, and rot and require less maintenance than wood counterparts.

The foam polymer core 314 also provides a solid substrate that anchors (e.g., grips) fasteners therein when, for example, installing fenestration hardware (e.g., 108). Accordingly, fasteners, such as nails, screws, bolts, or the like, are readily received and anchored (e.g., bite) within the foam polymer core 314 (or the foam polymer core 324 of the foam polymer sash member 304). Backers, fillers, blocks, or brackets inserted and fastened within hollow profile fenestration assemblies to facilitate hardware attachment of hinges, operators, locks, and the like are accordingly unnecessary with the foam polymer cores described herein.

Moreover, the foam polymer cores 314 (the foam polymer core 324 of the sash member 304, or both) provide a substrate within the polymer shells (312, 326, or both) that decreases voids otherwise present in hollow profile fenestration assemblies. In one example, the foam polymer core enhances the thermal performance of the fenestration assembly by decreasing convective heat transfer. Optionally, the foam core includes pores, cells, or the like (reticulated or non-reticulated) that provide interstitial cavities to further enhance thermal insulation.

In some examples, the polymer shell 312 is extruded with a single screw and a ready-to-use pellet. In other examples, the polymer shell 312 is extruded through a twin-screw extruder where a master batch (e.g., a super-composite) is mixed with virgin polymer and pushed through a die. In another example, the foam polymer core 314 is created with a specialized formulated polymer (e.g., PVC) and a blowing agent to create different densities of foam (e.g., between 0.08 and 0.3 specific gravity) before coextrusion with the polymer shell 312 in a single screw extruder. As described herein, the polymer shell 312 is coextruded along with the foam polymer core 314 ensuring complementary fitting of the foam polymer core 314 to the polymer shell 312.

As further shown in FIG. 3, in various examples, the foam polymer frame member 310 includes an optional cap layer 308 surrounding the exterior of the polymer shell 312 (e.g., fully enclosing or partially enclosing the polymer shell 312). The cap layer 308 is optionally a film coextruded with another extruder or otherwise applied (sprayed, dipped, or the like) to the exterior of the polymer shell 312. The cap layer 308 includes one or more of different weatherable polymers (e.g., acrylic, PVDF blends, PVC, acrylic and PVC blend, PVC and ASA blend, or weatherable PVC resins).

In additional examples, the foam polymer frame member 310 includes members (e.g., flexible fins, flanges, nailing flanges, or the like for sealing members, seals for interfaces with other components to seal against air and water infiltration) that are extruded (e.g., coextruded, cross-head extruded, or the like) with the fenestration frame 318 (or sash frame 302). The members include, but are not limited to, plasticized flexible PVC, thermoplastic elastomer (e.g., Alcyrn®), or the like that are pliable and permit penetration of fasteners such as staples, nails, or the like without fractures.

As further shown in FIG. 3, in various examples, the fenestration frame 318 includes an integral nailing flange 316 that is coextruded with the polymer shell 312 and the foam polymer core 314. The integral nailing flange 316 is coupled with surrounding materials (e.g., studs, beams, or the like) with fasteners extending through the flange and into the surrounding materials to facilitate the installation of the fenestration assembly 300.

In other examples, the integral nailing flange 316 is welded to the remainder of the fenestration frame 318 during the corner welding process. The nailing flange 316 facilitates installation of the assembly 300 to a building and additionally provides a moisture resistant barrier between the assembly 300 and the building at the interface therebetween.

FIG. 3 further shows a sash 302 including one or more foam polymer sash members 304 and a panel 322, such as a glass pane. The sash 302 is either movable or stationary. The one or more foam polymer sash members 304 are, in one example, similar to the one or more foam polymer frame members 310. For instance, the foam polymer sash members 304 includes a polymer shell 326 enveloping (fully or partially) a foam polymer core 324. The polymer shell 326 and foam polymer core 324 are coextruded together ensuring complementary fitting of the foam polymer core 324 to the polymer shell 326.

In various examples, the polymer shell 312 and foam polymer core 314 profiles of either or both of the sash 302 or fenestration frame 318 are welded together, for instance, at miter cut ends of the respective members.

Additionally, hardware, brackets, or the like are installed to the sash frame members 304 and frame members 310. In another example, an insulated glass unit (IGU) is installed within the sash 302, as the panel 322, and secured with a glazing bead. As one representative example, a casement window (or awning unit) includes four foam polymer frame members 310 welded together at ends of the members 310 (to form the frame), four foam polymer sash members 304 welded together at ends of the sash members 304 (to form the sash), panels 322 (e.g., translucent glass, insulated glass unit, or the like), one or more glazing beads, tape (e.g., silicone tape, glazing tape, or the like) and associated hardware.

In various examples, the foam polymer core 314 (and optionally the polymer shell 312) of a frame member 310 (or sash frame member 304) is welded with a planar end surface portion of the foam polymer core 314 (and optionally the polymer shell 312) of another frame member 310 (or another sash member 304), for instance at miter cut ends of the polymer frame member 310 (or sash frame member 304).

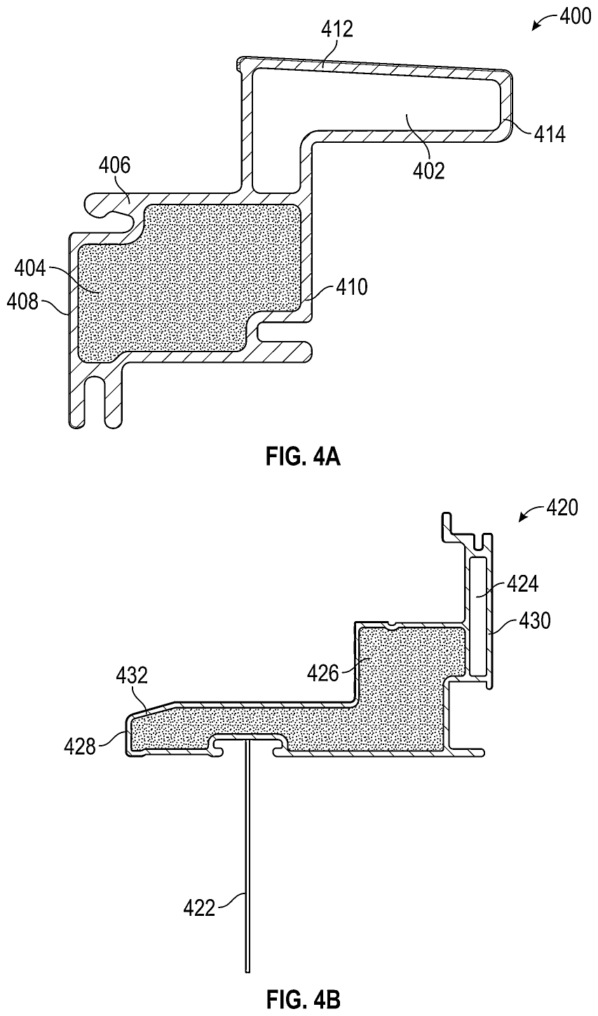

FIG. 4A is a cross-sectional view of a fenestration sash 400 including a coextruded foam polymer sash member 410 and a hollow sash member 412.

In various examples, the coextruded foam polymer sash member 410 includes a foam polymer core 404 and a polymer shell 406 embracing the foam polymer core 404 (e.g., fully enclosed or partially enclosed). As described herein, the polymer shell 406 braces the foam polymer core 404 during coextrusion of the polymer shell 406 along with the foam polymer core 404 ensuring complementary fitting of the foam polymer core 404 to the polymer shell 406. Optionally, the foam core 404 includes pores, cells, or the like (reticulated or non-reticulated) that provide interstitial cavities to further enhance thermal insulation. In other examples, the hollow sash member 412 includes a hollow core 402 surrounded by a polymer shell 414. In some examples, the hollow sash member 412 improves thermal performance of the fenestration sash 400, for instance, by providing a stagnant air cavity without including a foam polymer core therein. Hardware (e.g., hinges, locks, or the like) may be attached to the foam polymer core 404.

FIG. 4B is a cross-sectional view of a fenestration frame 420 including a coextruded foam polymer frame member 428 having a foam polymer core 426 and a hollow frame member 430 having a hollow core 424. The hollow frame member 430 provides a stagnant air cavity (assists with thermal performance) and is less expensive in some examples than the foam polymer core 426 used elsewhere in the frame member 428. In various examples, the hollow frame member 430 (or hollow sash member 412) includes hardware, mechanical devices, or the like (e.g., sensors, wiring for sensors, batteries for actuators, reinforcing members, insulation members, or the like) in the hollow core 424 (or hollow core 402 shown in FIG. 4A).

As shown in FIG. 4B, in various examples, the coextruded foam polymer frame member 428 includes a polymer shell 432 coextruded with the foam polymer core 426 and an installation flange 422 (or integral nailing flange). The installation flange 422 increases the torsion or bending strength of the fenestration frame 420, facilitating the installation of the fenestration assembly. In other examples, the installation flange 422 is welded during the corner welding process.

In various examples, fenestration assemblies include foam polymer cores 404 and 426 (shown in FIG. 4A and FIG. 4B, respectively) having first mechanical strength characteristics, and polymer shells 406 and 432 (shown in FIG. 4A and FIG. 4B, respectively) having second mechanical strength characteristics greater than the first mechanical strength characteristics. The polymer shells 406, 432 with the greater second mechanical strength characteristics brace the foam polymer cores 404, 426 against deformation. For instance, the polymer shell 432 (or 406) enhances the strength of the foam polymer core 426 (or 404) and provides a robust framework to support the coextruded foam polymer members.

In many examples, the foam polymer cores 404 and 426 (shown in FIG. 4A and FIG. 4B, respectively) enhance the thermal performance of the fenestration sash 400 and the fenestration frame 420. For instance, the foam polymer cores 404, 426, while potentially having lesser first mechanical strengths, provide greater first thermal insulation characteristics in comparison to second thermal insulation characteristics of the polymer shells 406 and 432 (shown in FIG. 4A and FIG. 4B, respectively).

In various examples, the foam core 404, 426 includes pores, cells, or the like (reticulated or non-reticulated) that provide interstitial cavities to further enhance thermal insulation. The porosity of the foam enhances the thermal insulation properties of the coextruded foam polymer members by decreasing convective heat transfer. The amount of porosity is optionally increased to enhance thermal insulation characteristics. Alternatively, the porosity is optionally attenuated to enhance mechanical strength characteristics.

In various other examples, the foam polymer cores 404 and 426 (shown in FIG. 4A and FIG. 4B) include a first thermal stability characteristic and the polymer shells 406 and 432 (shown in FIG. 4A and FIG. 4B) include a second thermal stability characteristic greater than the first thermal stability characteristic. Due to the greater thermal stability characteristic of the polymer shell 406, 432, the polymer shell braces the foam polymer core, and thereby limits expansion, contraction, and bending of the coextruded foam polymer member when exposed higher temperatures, loads, or the like.

In other instances, the foam polymer cores 404 and 426 (shown in FIG. 4A and FIG. 4B, respectively) include a first fill characteristic, and the polymer shells 406 and 432 (shown in FIG. 4A and FIG. 4B, respectively) include a second fill characteristic less than the first fill characteristic. The fill characteristic, in one example, represents the material volume. For instance, as shown in FIGS. 4A and 4B, the foam polymer cores 404, 426 provide a larger portion of the volume (or fill) of the fenestration sash 400 or frame 420 in comparison to the volume (fill) of the shells 406, 432.

In the embodiment of FIG. 4A and FIG. 4B, the foam polymer cores provide a greater fill characteristic, that is, has a greater volume of solid substrate that anchors (e.g., grips) fasteners therein. Accordingly, fasteners, such as nails, screws, bolts, or the like, are readily received and anchored (e.g., bite) within the foam polymer core. Backers, fillers, blocks, or brackets installed and fastened within hollow profile fenestration assemblies to facilitate hardware attachment of hinges, operators, locks, and the like are accordingly decreased with the foam polymer cores described herein. Moreover, in various examples, the foam polymer core provides planar surfaces (as opposed to edges) for welding, gluing, or the like as described herein.

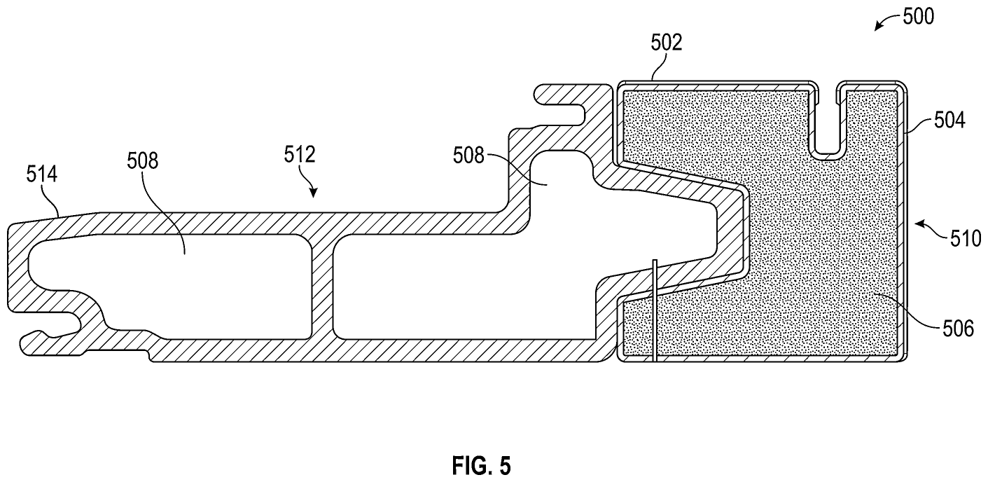

FIG. 5 illustrates another example of a fenestration assembly 500 in cross section. The fenestration assembly 500 includes a coextruded foam polymer member 510 having a foam polymer core 506 and a hollow member 512 having one or more hollow cores 508. As shown in FIG. 5 the coextruded foam polymer member 510 is coupled with the hollow member 512, with an adhesive, fastener, interference fit, or the like. In another example, the member 510 and the hollow member 512 are coextruded as integral components.

In various examples, the coextruded foam polymer member 510 includes a polymer shell 504 and a foam polymer core 506, wherein the polymer shell 504 braces the foam polymer core 506 against deformation, protects the core 506 from environmental characteristics (e.g., temperature, sunlight, or the like). In many other examples, the coextruded foam polymer member 510 includes a cap layer 502 surrounding the foam polymer member 510 (e.g., fully enclosing or partially enclosing the foam polymer member 510). The cap layer 502 is optionally coextruded with the polymer shell 504. The cap layer 502 is optionally placed on the exterior of the polymer shell 504 to enhance the weatherability of the fenestration assembly.

In other examples, the hollow member 512 has a hollow core 508 surrounded by a polymer shell 514. In some examples, the hollow cores 508 provide stagnant air cavities to improve the thermal performance of the fenestration assembly 500 without the inclusion of foam polymer core.

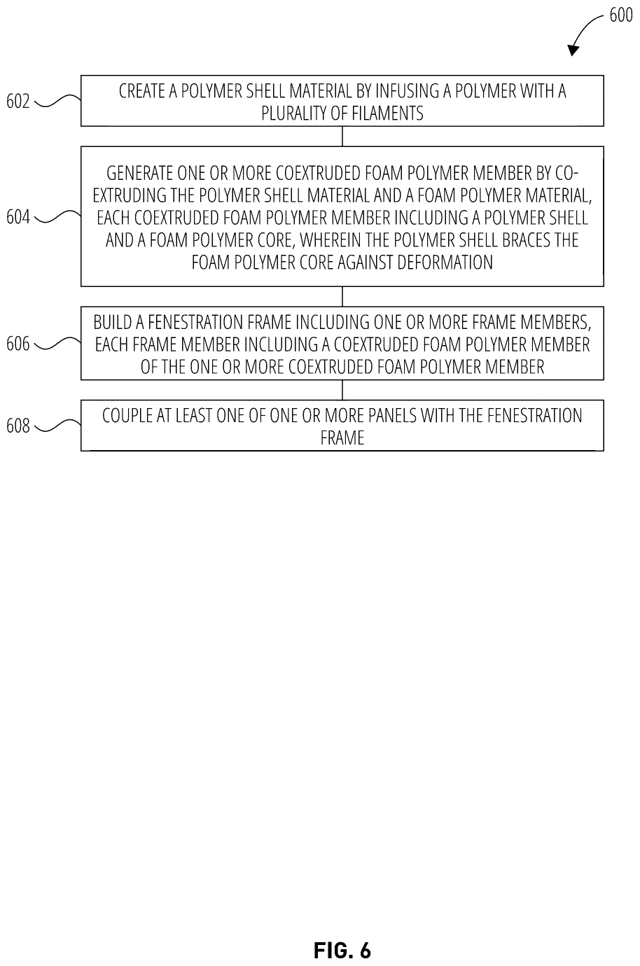

FIG. 6 shows one example of a method 600 for building a fenestration assembly 100, such as the fenestration assembly shown in FIG. 1. In describing the method 600, reference is made to one or more components, features, functions, steps, or the like previously described herein. Where convenient, reference is made to the components, features, functions, steps, or the like with reference numerals. Reference numerals provided are exemplary and are not exclusive. For instance, components, features, functions, steps, or the like described in the method 600 include, but are not limited to, corresponding numbered elements provided herein, other corresponding features described herein (both numbered and unnumbered) as well as their equivalents.

In block 602, method 600 creates a polymer shell material by infusing a polymer with a plurality of filaments.

The plurality of filaments in the polymer shell has a filament component including one or more of glass, mineral (e.g., wollastonite, calcium carbonate, talc, titanium dioxide (TiO2), or the like), organic fiber (e.g., cotton, wool, wood fiber, flax, hemp, or the like), a blend of glass and mineral, a blend of glass and organic fiber, a blend of mineral and organic fiber, a blend of glass, mineral and organic fiber, or the like. In one example, the polymer shell includes a blend of glass and mineral between 15% and 47% by weight. In another example, the polymer shell includes a blend of glass and mineral between 5% and 60% by weight. In other examples, a blend of glass and mineral between 55% and 60% by weight. In another instance, a blend of glass and mineral between 40% and 48% by weight. In several other examples, a blend of glass and mineral between 25% and 35% by weight. In various other examples, a blend of glass and mineral between 12% and 17% by weight, or the like.

In block 604, method 600 generates one or more coextruded foam polymer members by co-extruding the polymer shell material and a foam polymer material, each coextruded foam polymer member including a polymer shell and a foam polymer core, wherein the polymer shell braces the foam polymer core against deformation.

In block 606, method 600 builds a fenestration frame including one or more frame members, each frame member including a coextruded foam polymer member of the one or more coextruded foam polymer member. In block 608, method 600 couples at least one of one or more panels with the fenestration frame.

### Various Notes and Examples

Example 1 is a fenestration assembly comprising: a fenestration frame having one or more frame members; at least one of one or more panels coupled with the fenestration frame; and wherein the one or more frame members each include, a coextruded foam polymer member having: a foam polymer core; a polymer shell jacketing the foam polymer core and coextruded with the foam polymer core; and wherein the polymer shell braces the foam polymer core against deformation.

In Example 2, the subject matter of Example 1 includes, wherein at least one frame member of the one or more frame members includes a hollow core surrounded by a second polymer shell.

In Example 3, the subject matter of Examples 1-2 includes, wherein the polymer shell includes a polymer infused with a plurality of filaments.

In Example 4, the subject matter of Example 3 includes, (nylons), TPO, HIPS, and TPUs.

In Example 5, the subject matter of Example 3-4 includes, % by weight.

In Example 6, the subject matter of Example 3-5 includes, % by weight.

In Example 7, the subject matter of Example 3-6 includes, % by weight.

In Example 8, the subject matter of Example 3-7 includes, % by weight.

In Example 9, the subject matter of Example 3-8 includes, % by weight.

In Example 10, the subject matter of Example 3-9 includes, % by weight.

In Example 11, the subject matter of Examples 1-10 includes, wherein the polymer shell includes a polymer infused with a plurality of particles.

In Example 12, the subject matter of Examples 1-11 includes, wherein the coextruded foam polymer member includes: a cap layer coextruded with the polymer shell, the cap layer placed on an exterior of the polymer shell.

In Example 13, the subject matter of Examples 1-12 includes, wherein the polymer shell includes a nailing flange.

In Example 14, the subject matter of Examples 1-13 includes, a sash coupled with the fenestration frame, the sash having a sash frame including one or more sash frame members, the one or more sash frame members each includes a second coextruded foam polymer member.

In Example 15, the subject matter of Example 14 includes, wherein the one or more panels include one or more translucent panels seated in the sash frame.

In Example 16, the subject matter of Examples 1-15 includes, wherein the foam polymer core includes a first thermal insulation characteristic and the polymer shell includes a second thermal insulation characteristic less than the first thermal insulation characteristic.

In Example 17, the subject matter of Examples 1-16 includes, wherein the foam polymer core includes a first mechanical strength characteristic and the polymer shell includes a second mechanical strength characteristic, the second mechanical strength characteristic greater than the first mechanical strength characteristic.

In Example 18, the subject matter of Example 17 includes, wherein the foam polymer core includes a first fill characteristic and the polymer shell includes a second fill characteristic, the second fill characteristic less than the first fill characteristic; and wherein the polymer shell having the greater second mechanical strength characteristic braces the foam polymer core against deformation.

In Example 19, the subject matter of Examples 1-18 includes, wherein the foam polymer core includes a first thermal stability characteristic and the polymer shell includes a second thermal stability characteristic, the second thermal stability characteristic greater than the first thermal stability characteristic.

In Example 20, the subject matter of Examples 1-19 includes, wherein the foam polymer core includes a first fill characteristic and the polymer shell includes a second fill characteristic less than the first fill characteristic; wherein the foam polymer core includes a first mechanical strength characteristic and the polymer shell includes a second mechanical strength characteristic greater than the first mechanical strength characteristic; and wherein the foam polymer core includes a first thermal stability characteristic and the polymer shell includes a second thermal stability characteristic greater than the first thermal stability characteristic.

Example 21 is a fenestration assembly comprising: a fenestration frame having one or more frame members; at least one of one or more panels coupled with the fenestration frame, wherein the one or more frame members each include, a coextruded foam polymer member having: a foam polymer core, the foam polymer core including a planar end surface; a polymer shell jacketing the foam polymer core and coextruded with the foam polymer core; and wherein the polymer shell braces the foam polymer core against deformation; and a first frame member, wherein at least the foam polymer core of the first frame member is welded with a portion of the planar end surface of the foam polymer core of a second frame member.

In Example 22, the subject matter of Example 21 includes, wherein the polymer shell includes a polymer infused with a plurality of particles.

In Example 23, the subject matter of Examples 21-22 includes, wherein the polymer shell includes a polymer infused with a plurality of filaments.

In Example 24, the subject matter of Example 23 includes,), cotton, wool, wood fiber, flax, or hemp.

In Example 25, the subject matter of Examples 23-24 includes, % by weight.

In Example 26, the subject matter of Examples 23-25 includes, % by weight.

In Example 27, the subject matter of Examples 23-26 includes, % by weight.

In Example 28, the subject matter of Examples 23-27 includes, % by weight.

In Example 29, the subject matter of Examples 23-28 includes, % by weight.

In Example 30, the subject matter of Examples 23-29 includes, % by weight.

In Example 31, the subject matter of Examples 21-30 includes, wherein the coextruded foam polymer member includes: a cap layer coextruded with the polymer shell, the cap layer placed on an exterior of the polymer shell.

In Example 32, the subject matter of Examples 21-31 includes, wherein the polymer shell includes a nailing flange.

In Example 33, the subject matter of Examples 21-32 includes, a sash coupled with the fenestration frame, the sash having a sash frame including one or more sash frame members, the one or more sash frame members each includes a second coextruded foam polymer member.

In Example 34, the subject matter of Example 33 includes, wherein the one or more panels include one or more translucent panels seated in the sash frame.

In Example 35, the subject matter of Examples 21-34 includes, wherein the foam polymer core includes a first thermal insulation characteristic and the polymer shell includes a second thermal insulation characteristic less than the first thermal insulation characteristic.

In Example 36, the subject matter of Examples 21-35 includes, wherein the foam polymer core includes a first fill characteristic and the polymer shell includes a second fill characteristic less than the first fill characteristic.

In Example 37, the subject matter of Examples 21-36 includes, wherein the foam polymer core includes a first mechanical strength characteristic and the polymer shell includes a second mechanical strength characteristic greater than the first mechanical strength characteristic.

In Example 38, the subject matter of Examples 21-37 includes, wherein the foam polymer core includes a first thermal stability characteristic and the polymer shell includes a second thermal stability characteristic greater than the first thermal stability characteristic.

In Example 39, the subject matter of Examples 21-38 includes, wherein the foam polymer core includes a first fill characteristic and the polymer shell includes a second fill characteristic less than the first fill characteristic; wherein the foam polymer core includes a first mechanical strength characteristic and the polymer shell includes a second mechanical strength characteristic greater than the first mechanical strength characteristic; and wherein the foam polymer core includes a first thermal stability characteristic and the polymer shell includes a second thermal stability characteristic greater than the first thermal stability characteristic.

Example 40 is a method of manufacturing a fenestration assembly, the method comprising: creating a polymer shell material by infusing a polymer with a plurality of filaments; generating one or more coextruded foam polymer member by co-extruding the polymer shell material and a foam polymer material, each coextruded foam polymer member including a polymer shell and a foam polymer core, wherein the polymer shell braces the foam polymer core against deformation; building a fenestration frame including one or more frame members, each frame member including a coextruded foam polymer member of the one or more coextruded foam polymer member; and coupling at least one of one or more panels with the fenestration frame.

In Example 41, the subject matter of Example 40 includes, wherein generating the one or more coextruded foam polymer member further comprises: coextruding a cap layer material with the polymer shell material and the foam polymer material, the coextruded foam polymer member including a cap layer placed on an exterior of the polymer shell.

In Example 42, the subject matter of Examples 40-41 includes, wherein the polymer shell includes a nailing flange.

In Example 43, the subject matter of Examples 40-42 includes, coupling a sash with the fenestration frame the sash having a sash frame including one or more sash frame members, the one or more sash frame members each including a second coextruded foam polymer member.

In Example 44, the subject matter of Example 43 includes, seating at least one panel of the one or more panels in the sash frame, wherein the at least one panel is a translucent panel.

In Example 45, the subject matter of Examples 40-44 includes, wherein the foam polymer core includes a first thermal insulation characteristic and the polymer shell includes a second thermal insulation characteristic less than the first thermal insulation characteristic.

In Example 46, the subject matter of Examples 40-45 includes, wherein the foam polymer core includes a first fill characteristic and the polymer shell includes a second fill characteristic less than the first fill characteristic.

In Example 47, the subject matter of Examples 40-46 includes, wherein the foam polymer core includes a first mechanical strength characteristic and the polymer shell includes a second mechanical strength characteristic greater than the first mechanical strength characteristic.

In Example 48, the subject matter of Examples 40-47 includes, wherein the foam polymer core includes a first thermal stability characteristic and the polymer shell includes a second thermal stability characteristic greater than the first thermal stability characteristic.

In Example 49, the subject matter of Examples 40-48 includes, wherein the foam polymer core includes a first fill characteristic and the polymer shell includes a second fill characteristic less than the first fill characteristic; wherein the foam polymer core includes a first mechanical strength characteristic and the polymer shell includes a second mechanical strength characteristic greater than the first mechanical strength characteristic; and wherein the foam polymer core includes a first thermal stability characteristic and the polymer shell includes a second thermal stability characteristic greater than the first thermal stability characteristic.

In Example 50, the subject matter of Examples 40-49 includes,), cotton, wool, wood fiber, flax, or hemp.

In Example 51, the subject matter of Examples 40-50 includes, % by weight.

In Example 52, the subject matter of Examples 40-51 includes, % by weight.

In Example 53, the subject matter of Examples 40-52 includes, % by weight.

In Example 54, the subject matter of Examples 40-53 includes, % by weight.

In Example 55, the subject matter of Examples 40-54 includes, % by weight.

In Example 56, the subject matter of Examples 40-55 includes, % by weight.

Example 57 is at least one machine-readable medium including instructions that, when executed by processing circuitry, cause the processing circuitry to perform operations to implement of any of Examples 1-56.

Example 58 is an apparatus comprising means to implement of any of Examples 1-56.

Example 59 is a system to implement of any of Examples 1-56.

Example 60 is a method to implement of any of Examples 1-56.

Each of these non-limiting examples can stand on its own, or can be combined in various permutations or combinations with one or more of the other examples.

The above description includes references to the accompanying drawings, which form a part of the detailed description. By way of illustration, the drawings show specific embodiments in which the invention can be practiced. These embodiments are also referred to herein as “aspects” or “examples.” Such aspects or examples can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to particular aspects or examples (or one or more features thereof), or with respect to other Aspects (or one or more features thereof) shown or described herein.

In the event of inconsistent usages between this document and any documents incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” or the like are used merely as labels and are not intended to impose numerical requirements on their objects.

Geometric terms, such as “parallel,” “perpendicular,” “round,” or “square,” are not intended to require absolute mathematical precision unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b) to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending for an unclaimed disclosed feature to be essential to any claim. Rather, inventive subject matter may lie in less than all features of a particular disclosed embodiment. Thus, the following claims are hereby incorporated into the Detailed Description as aspects, examples, or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A fenestration assembly comprising:
a fenestration frame having one or more frame members;
at least one of one or more panels coupled with the fenestration frame; and
wherein the one or more frame members each include a coextruded foam polymer member having:
a foam polymer core;
a polymer shell jacketing the foam polymer core and coextruded with the foam polymer core; and
wherein the polymer shell braces the foam polymer core against deformation.

2. The fenestration assembly of claim 1, wherein at least one frame member of the one or more frame members includes a hollow core surrounded by a second polymer shell.

3. The fenestration assembly of claim 1, wherein the polymer shell includes a polymer infused with a plurality of filaments.

4. The fenestration assembly of claim 3, wherein the polymer includes at least one of PVC, ABS, cPVC, PE (polyethylene), polypropylene, ASA, PMMA (acrylics), PPO, PC, PA 6, PA 6/6 (nylons), TPO, HIPS, and TPUs.

5. The fenestration assembly of claim 3, wherein the polymer shell has a filament component between 15% and 47% by weight.

6. The fenestration assembly of claim 3, wherein the polymer shell has a filament component between 5% and 60% by weight.

7. The fenestration assembly of claim 3, wherein the polymer shell has a filament component between 55% and 60% by weight.

8. The fenestration assembly of claim 3, wherein the polymer shell has a filament component between 40% and 48% by weight.

9. The fenestration assembly of claim 3, wherein the polymer shell has a filament component between 25% and 35% by weight.

10. The fenestration assembly of claim 3, wherein the polymer shell has a filament component between 12% and 17% by weight.

11. The fenestration assembly of claim 1, wherein the polymer shell includes a polymer infused with a plurality of particles.

12. The fenestration assembly of claim 1, wherein the coextruded foam polymer member includes:
a cap layer coextruded with the polymer shell, the cap layer placed on an exterior of the polymer shell.

13. The fenestration assembly of claim 1, wherein the polymer shell includes a nailing flange.

14. The fenestration assembly of claim 1, further comprising:
a sash coupled with the fenestration frame, the sash having a sash frame including one or more sash frame members, the one or more sash frame members each includes a second coextruded foam polymer member.

15. The fenestration assembly of claim 14, wherein the one or more panels include one or more translucent panels seated in the sash frame.

16. The fenestration assembly of claim 1, wherein the foam polymer core includes a first thermal insulation characteristic and the polymer shell includes a second thermal insulation characteristic less than the first thermal insulation characteristic.

17. The fenestration assembly of claim 1, wherein the foam polymer core includes a first mechanical strength characteristic and the polymer shell includes a second mechanical strength characteristic, the second mechanical strength characteristic greater than the first mechanical strength characteristic.

18. The fenestration assembly of claim 17,
wherein the foam polymer core includes a first fill characteristic and the polymer shell includes a second fill characteristic, the second fill characteristic less than the first fill characteristic; and
wherein the polymer shell having the greater second mechanical strength characteristic braces the foam polymer core against deformation.

19. The fenestration assembly of claim 1, wherein the foam polymer core includes a first thermal stability characteristic and the polymer shell includes a second thermal stability characteristic, the second thermal stability characteristic greater than the first thermal stability characteristic.

20. The fenestration assembly of claim 1,
wherein the foam polymer core includes a first fill characteristic and the polymer shell includes a second fill characteristic less than the first fill characteristic;
wherein the foam polymer core includes a first mechanical strength characteristic and the polymer shell includes a second mechanical strength characteristic greater than the first mechanical strength characteristic; and
wherein the foam polymer core includes a first thermal stability characteristic and the polymer shell includes a second thermal stability characteristic greater than the first thermal stability characteristic.

21. A fenestration assembly comprising:
a fenestration frame having one or more frame members;
at least one of one or more panels coupled with the fenestration frame, wherein the one or more frame members each include a coextruded foam polymer member having:
a foam polymer core, the foam polymer core including a planar end surface;
a polymer shell jacketing the foam polymer core and coextruded with the foam polymer core; and
wherein the polymer shell braces the foam polymer core against deformation; and
a first frame member, wherein at least the foam polymer core of the first frame member is welded with a portion of the planar end surface of the foam polymer core of a second frame member.

22. The fenestration assembly of claim 21, wherein the polymer shell includes a polymer infused with a plurality of particles.

23. The fenestration assembly of claim 21, wherein the polymer shell includes a polymer infused with a plurality of filaments.

24. The fenestration assembly of claim 23, wherein the plurality of filaments includes at least one of glass, calcium inosilicate mineral, calcium carbonate, talc, Titanium dioxide (TiO2), cotton, wool, wood fiber, flax, or hemp.

25. The fenestration assembly of claim 23, wherein the polymer shell has a filament component between 15% and 47% by weight.

26. The fenestration assembly of claim 23, wherein the polymer shell has a filament component between 5% and 60% by weight.

27. The fenestration assembly of claim 23, wherein the polymer shell has a filament component between 55% and 60% by weight.

28. The fenestration assembly of claim 23, wherein the polymer shell has a filament component between 40% and 48% by weight.

29. The fenestration assembly of claim 23, wherein the polymer shell has a filament component between 25% and 35% by weight.

30. The fenestration assembly of claim 23, wherein the polymer shell has a filament component between 12% and 17% by weight.

31. The fenestration assembly of claim 21, wherein the coextruded foam polymer member includes:
a cap layer coextruded with the polymer shell, the cap layer placed on an exterior of the polymer shell.

32. The fenestration assembly of claim 21, wherein the polymer shell includes a nailing flange.

33. The fenestration assembly of claim 21, further comprising:
a sash coupled with the fenestration frame, the sash having a sash frame including one or more sash frame members, the one or more sash frame members each includes a second coextruded foam polymer member.

34. The fenestration assembly of claim 33, wherein the one or more panels include one or more translucent panels seated in the sash frame.

35. The fenestration assembly of claim 21, wherein the foam polymer core includes a first thermal insulation characteristic and the polymer shell includes a second thermal insulation characteristic less than the first thermal insulation characteristic.

36. The fenestration assembly of claim 21, wherein the foam polymer core includes a first fill characteristic and the polymer shell includes a second fill characteristic less than the first fill characteristic.

37. The fenestration assembly of claim 21, wherein the foam polymer core includes a first mechanical strength characteristic and the polymer shell includes a second mechanical strength characteristic greater than the first mechanical strength characteristic.

38. The fenestration assembly of claim 21, wherein the foam polymer core includes a first thermal stability characteristic and the polymer shell includes a second thermal stability characteristic greater than the first thermal stability characteristic.

39. The fenestration assembly of claim 21,
wherein the foam polymer core includes a first fill characteristic and the polymer shell includes a second fill characteristic less than the first fill characteristic;
wherein the foam polymer core includes a first mechanical strength characteristic and the polymer shell includes a second mechanical strength characteristic greater than the first mechanical strength characteristic; and
wherein the foam polymer core includes a first thermal stability characteristic and the polymer shell includes a second thermal stability characteristic greater than the first thermal stability characteristic.

40. A method of manufacturing a fenestration assembly, the method comprising:
creating a polymer shell material by infusing a polymer with a plurality of filaments;
generating one or more coextruded foam polymer member by co-extruding the polymer shell material and a foam polymer material, each coextruded foam polymer member including a polymer shell and a foam polymer core, wherein the polymer shell braces the foam polymer core against deformation;
building a fenestration frame including one or more frame members, each frame member including a coextruded foam polymer member of the one or more coextruded foam polymer member; and
coupling at least one of one or more panels with the fenestration frame.

41. The method of claim 40, wherein generating the one or more coextruded foam polymer member further comprises:
coextruding a cap layer material with the polymer shell material and the foam polymer material, the coextruded foam polymer member including a cap layer placed on an exterior of the polymer shell.

42. The method of claim 40, wherein the polymer shell includes a nailing flange.

43. The method of claim 40, further comprising:
coupling a sash with the fenestration frame the sash having a sash frame including one or more sash frame members, the one or more sash frame members each including a second coextruded foam polymer member.

44. The method of claim 43, seating at least one panel of the one or more panels in the sash frame, wherein the at least one panel is a translucent panel.

45. The method of claim 40, wherein the foam polymer core includes a first thermal insulation characteristic and the polymer shell includes a second thermal insulation characteristic less than the first thermal insulation characteristic.

46. The method of claim 40, wherein the foam polymer core includes a first fill characteristic and the polymer shell includes a second fill characteristic less than the first fill characteristic.

47. The method of claim 40, wherein the foam polymer core includes a first mechanical strength characteristic and the polymer shell includes a second mechanical strength characteristic greater than the first mechanical strength characteristic.

48. The method of claim 40, wherein the foam polymer core includes a first thermal stability characteristic and the polymer shell includes a second thermal stability characteristic greater than the first thermal stability characteristic.

49. The method of claim 40, wherein the foam polymer core includes a first fill characteristic and the polymer shell includes a second fill characteristic less than the first fill characteristic;
wherein the foam polymer core includes a first mechanical strength characteristic and the polymer shell includes a second mechanical strength characteristic greater than the first mechanical strength characteristic; and
wherein the foam polymer core includes a first thermal stability characteristic and the polymer shell includes a second thermal stability characteristic greater than the first thermal stability characteristic.

50. The method of claim 40, wherein the plurality of filaments includes at least one of glass, calcium inosilicate mineral, calcium carbonate, talc, Titanium dioxide (TiO2), cotton, wool, wood fiber, flax, or hemp.

51. The method of claim 40, wherein the polymer shell has a filament component between 15% and 47% by weight.

52. The method of claim 40, wherein the polymer shell has a filament component between 5% and 60% by weight.

53. The method of claim 40, wherein the polymer shell has a filament component between 55% and 60% by weight.

54. The method of claim 40, wherein the polymer shell has a filament component between 40% and 48% by weight.

55. The method of claim 40, wherein the polymer shell has a filament component between 25% and 35% by weight.

56. The method of claim 40, wherein the polymer shell has a filament component between 12% and 17% by weight.
